(19) United States
(12) Patent Application Publication
(10) Pub. No.: US 2006/0106838 A1
(43) Pub. Date: May 18, 2006

(54) Apparatus, system, and method for validating files

(76) Inventors: Abiola Oladipupo Ayediran, Cary, NC (US); David Carroll Challener, Raleigh, NC (US); Justin Tyler Dubs, Raleigh, NC (US); John Hancock Nicholson III, Durham, NC (US); Jennifer Greenwood Zawacki, Hillsborough, NC (US)

Correspondence Address: KUNZLER & ASSOCIATES, 8 EAST BROADWAY, SUITE 600, SALT LAKE CITY, UT, 84111, US

(21) Appl. No.: 10/973,215

(22) Filed: Oct. 26, 2004

(51) Int. Cl. G06F 7/00

(52) U.S. Cl. 707/101

(57) ABSTRACT

An apparatus, system, and method are disclosed for validating files. In one embodiment, a target module determines if an operation is to be performed on a file. If the operation is to be performed on the file, an identification module identifies the file extension of the file and a characterization module characterizes the file format of the file. A comparison module compares the file format of the file to the expected file format corresponding to the file extension of the file. A validation module validates the file if the file format matches the expected file format. The validation module may block the operation if the file is invalid.

### BACKGROUND OF THE INVENTION

1. Field of the Invention

This invention relates to validating files and more particularly relates to validating that a file format matches a file extension.

2. Description of the Related Art

A file used by a data processing device typically includes a file extension. The file extension identifies the file type, including the format of data in the file and requirements for processing the file. For example, a file organized using the mpeg-1 audio layer 3 (“MP3”) format defined by the Moving Picture Experts Group typically has a ‘mp3’ file extension. The ‘mp3’ extension appended to a file name identifies the file as a MP3 audio file. In addition, the ‘mp3’ extension indicates to the data processing device how to use the file. For example, the ‘mp3’ extension indicates that the file should be processed using MP3 player software.

File extensions are often used to manage files by rapidly identifying the type of each file. Managing files may include placing restrictions on files. For example, restrictions may be imposed on performing operations on files with specified file extensions to prevent illegal operations such as the unauthorized duplication of copyrighted material or to prevent potentially damaging operations such as the execution of a computer virus. For example, a backup operation may be designed to save specified types of files. The backup operation may copy document files indicated by a ‘doc’ file extension and source code files indicated by a ‘c’ file extension to a backup storage device, but not copy audio files with a ‘.mp3’ extension to avoid propagating an illegal copy of an audio file. In an alternate example, an operator may configure a system to block the transfer of files with a specified file extension such as a ‘mp3’ file extension.

A user may attempt to circumvent restrictions through disguising a file by changing the file extension of the file. For example, the user may rename a file named ‘music.mp3’ to ‘music.doc’ to avoid restrictions on ‘mp3’ files such as the restriction on backing up files with ‘mp3’ extensions. Changing the file extension prevents the operator from managing files using only the file extension to identify files, and allowing users to maintain files that may cause damage to one or more computer systems or that may be illegal to propagate.

From the foregoing discussion, it should be apparent that a need exists for an apparatus, system, and method that validate that the file format of a file matches the expected file format indicated by the file extension. Beneficially, such an apparatus, system, and method would prevent users from avoiding restrictions by changing file extensions.

### SUMMARY OF THE INVENTION

The present invention has been developed in response to the present state of the art, and in particular, in response to the problems and needs in the art that have not yet been fully solved by currently available validation systems. Accordingly, the present invention has been developed to provide an apparatus, system, and method for validating a file format that overcome many or all of the above-discussed shortcomings in the art.

The apparatus to validate a file is provided with a logic unit containing a plurality of modules configured to functionally execute the necessary steps of validating that a file format matches a file extension. These modules in the described embodiments include a format record, an identification module, a characterization module, a comparison module, and a validation module.

The format record includes an expected file format and a corresponding file extension. The expected file format is a description of one or more characteristics of a file common to all files of a given type. In one embodiment, the expected file format is a file format identifier and may include a specified offset to a specified data word in a file. In an alternate embodiment, the expected file format is a character encoding scheme.

The identification module identifies the file extension of a file such as the ‘doc’ file extension. The characterization module characterizes the actual file format of the file. In one embodiment, the characterization module characterizes the file format using data from the format record. For example, the characterization module may characterize the file format of the file by reading a data word from a location of the file indicated by a specified offset. In an alternate embodiment, the characterization module characterizes the file format of the file by identifying the character encoding scheme of the file.

The comparison module compares the file format of the file characterized by the characterization module to the expected file format corresponding to the file extension of the file. The validation module validates the file if the file format matches the expected file format. For example, if the file format of the file and the expected file format are identical data words, the validation module may validate file. The apparatus validates that the file format of a file matches the expected file format for the file extension of the file.

A system of the present invention is also presented to validate a file. The system may be embodied data processing device such as a server. In particular, the system, in one embodiment, includes memory module comprising a format record, and a processor module comprising an identification module, a characterization module, a comparison module, and a validation module. In addition, the processor module may include a target module.

The format record includes an expected file format and a corresponding file extension. The identification module identifies the file extension of a file and the characterization module characterizes the file format of the file. The comparison module compares the file format of the file to the expected file format corresponding to the file extension of the file and the validation module validates the file if the file format matches the expected file format.

In one embodiment, the target module determines if an operation is to be performed on the file. If the operation is to be performed on the file, the format record, identification module, characterization module, comparison module, and validation module validate the file. The validation module further allows the operation to proceed if the file is validated but blocks the operation if the file is not valid. In one embodiment, the system includes a network configured with a plurality of data processing devices. The format record, the identification module, the characterization module, the comparison module and the validation module may be configured to validate a plurality of files on the data processing devices. In a certain embodiment, the files are validated before each file is backed up during backup operation. The system may prevent the propagation of illegal files by validating that each file's file format matches the expected file format for the file's extension.

A method of the present invention is also presented for validating a file. The method in the disclosed embodiments substantially includes the steps necessary to carry out the functions presented above with respect to the operation of the described apparatus and system. In one embodiment, the method includes maintaining a file format, identifying a file extension, characterizing a file format, comparing the file format to an expected file format, and validating a file.

A memory module maintains a format record comprising an expected file format and a corresponding file extension. In one embodiment, a target module determines if an operation is to be performed on the file. If the operation is to be performed on the file, an identification module identifies the file extension of a file and a characterization module characterizes the file format of the file. A comparison module compares the file format of the file to the expected file format corresponding to the file extension of the file. A validation module validates the file if the file format matches the expected file format. The validation module may block the operation if the file is invalid.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The present invention validates that the file format of a file matches the expected file format for the file extension of the file. In addition, the present invention may block operations for invalid files. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a validation system in accordance with the present invention;

FIG. 2 is a schematic block diagram illustrating one embodiment of a validation apparatus of the present invention;

FIG. 3 is a schematic block diagram illustrating one embodiment of a data processing device of the present invention;

FIG. 4 is a schematic block diagram illustrating one embodiment of a network system of the present invention;

FIG. 5 is a schematic flow chart diagram illustrating one embodiment of a validation method in accordance with the present invention;

FIG. 6 is a schematic flow chart diagram illustrating one embodiment of an operation validation method of the present invention; and

FIG. 7 is a diagram illustrating one embodiment of a format record in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

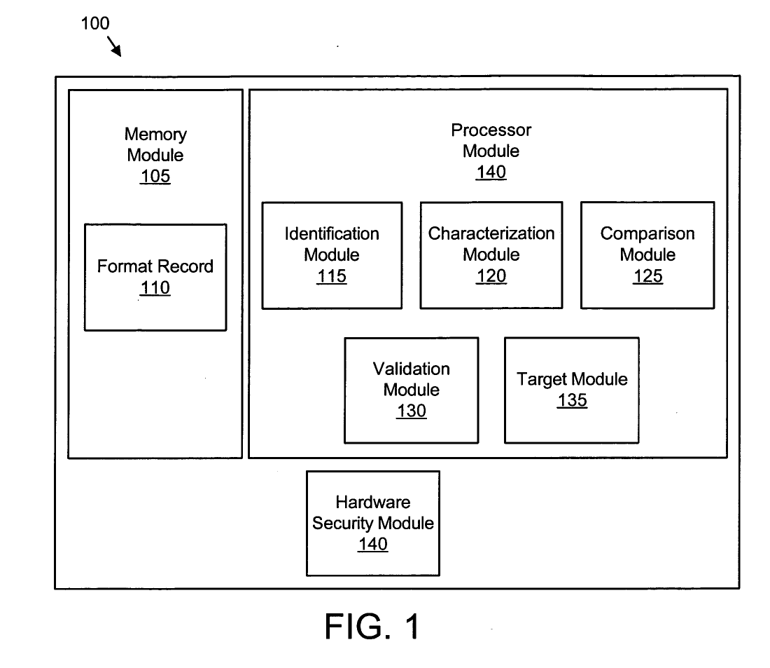

FIG. 1 is a schematic block diagram illustrating one embodiment of a validation system 100 of the present invention. The system 100 includes a memory module 105 comprising a format record 110, and a processing module 140 comprising an identification module 115, a characterization module 120, a comparison module 125, a validation module 130, a target module 135, and a hardware security module 140.

The memory module 105 and processor module 140 process digital data in a manner that is well known to those skilled in the art. The format record 110 includes an expected file format and a corresponding file extension. In one embodiment, the target module 135 determines if an operation is to be performed on the file. If the operation is to be performed on the file, the identification module 115 identifies a file extension of the file. For example, the identification module 115 may identify the file extension of the file ‘quarterlyexpenses.xls’ as ‘xls.’

The characterization module 120 characterizes the file format of the file. The comparison module 125 compares the file format of the file to the expected file format corresponding to the file extension of the file. The validation module 130 validates the file if the file format matches the expected file format. In one embodiment, the validation module 130 allows the operation to proceed if the file is validated but blocks the operation if the file is not validated.

In one embodiment, the system includes a network configured with a plurality of data processing devices. The format record 110, the identification module 115, the characterization module 120, the comparison module 125 and the validation module 130 may validate a plurality of files on the data processing devices. In a certain embodiment, each validated file is backed up during a backup operation.

In one embodiment, the validation module 130 validates the file in cooperation with the hardware security module 140. The hardware security module 140 validates files in secure file transfers. For example, the hardware security module 140 may be one or more semiconductor devices conforming to the Trusted Computer Group PC Specific Implementation Specification published by the Trusted Computer Group of Portland, Oreg. In a certain embodiment, the validation module 130 communicates validation information to the hardware security module 140. The hardware security module 140 may only transfer validated files.

The system 100 may prevent the propagation of illegal files by validating that each file's file format matches the expected file format for the file's extension. For example, the system 100 may prevent the propagation through backup of copyrighted audio and video files from data processing devices on a network.

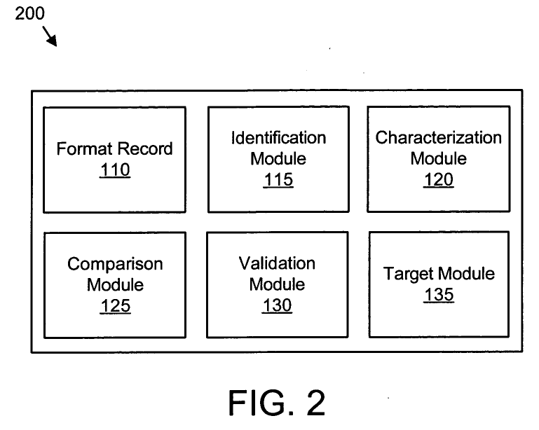

FIG. 2 is a schematic block diagram illustrating one embodiment of a validation apparatus 200 of the present invention. The apparatus 200 includes a format record 110, an identification module 115, a characterization module 120, a comparison module 125, and a validation module 130. In one embodiment, the apparatus 200 also includes a test module 135.

The format record 110 comprises an expected file format and a corresponding file extension. The expected file format is a description of one or more characteristics of a file common to files of a given type. In one embodiment, the expected file format is a file format identifier and may include a specified offset to a specified data word in a file. For example, the expected file format identifier may specify the sixteen bit (16b) hexadecimal data word ‘76’x located at an offset of forty-eight bytes (48B) from the start of a file. In an alternate embodiment, the expected file format is a character encoding scheme. For example, the expected file format may specify the use of the American standard code for information interchange (“ASCII”) character encoding scheme.

The identification module 115 identifies the file extension of a file. For example, the identification module 115 identifies the file extension of the file ‘music.mp3’ as ‘mp3.’ The characterization module 120 characterizes the file format of the file. In one embodiment, the characterization module 120 characterizes the file format using data from the format record. For example, if the identification module 115 identified the file extension of a file as ‘xyz’ and the format record 110 specified that the expected file format for the file extension ‘xyz’ comprised the thirty-two bit (32b) hexadecimal data word ‘F976’x at an offset of six bytes (6B) from the beginning of the file, the characterization module 120 would characterize the file format as the thirty-two bit (32b) data word read from the location with an offset of six bytes (6B) in the file. In an alternate embodiment, the characterization module 120 characterizes the file format of the file by identifying the character encoding scheme of the file. For example, the characterization module 120 may identify a file's character encoding scheme as ASCII and characterize the file as having an ASCII file format.

The comparison module 125 compares the file format of the file characterized by the characterization module 120 to the expected file format from the format record 110 corresponding to the file extension of the file. For example, if the characterization module 120 characterized the file format by reading the hexadecimal data word ‘F976’x from an offset of six bytes (6B) in the file as in the example above, the comparison module 125 would compare the file format value ‘F976’x with the expected file format value ‘F976’x from the format record 110.

The validation module 130 validates the file if the file format matches the expected file format. From the previous example, because the file format value ‘F976’x matches the expected file format value ‘F976’x, the validation module 130 validates the file. In an alternate embodiment, the apparatus 200 scans a plurality files to identify valid and invalid files. The apparatus 200 may scan the files regardless of whether an operation is targeted to be performed on the files. The apparatus 200 validates that the file format of a file matches the expected file format for the file extension of the file.

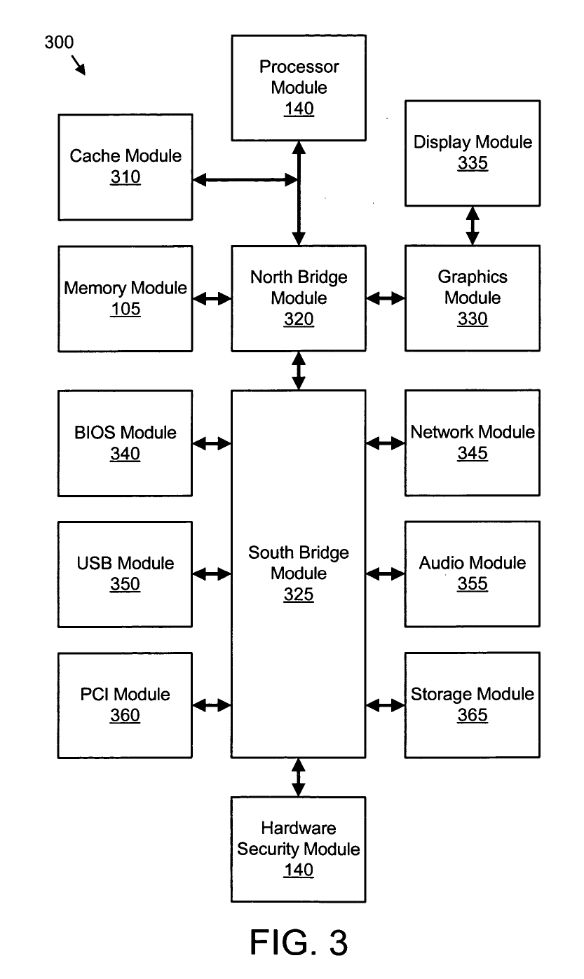

FIG. 3 is a schematic block diagram illustrating one embodiment of a data processing device 300 of the present invention. The data processing device 300 includes a processor module 140, a cache module 310, a memory module 105, a north bridge module 320, a south bridge module 325, a graphics module 330, a display module 335, a BIOS module 340, a network module 345, a USB module 350, an audio module 355, a PCI module 360, a storage module 365, and a hardware security module 140. In addition, the data processing device 300 functions in a manner that is well know by those skilled in the art.

In one embodiment, the memory module 105 comprises the format record 110. For example, the memory module 105 may be a dynamic random access memory (“DRAM”) storing the format record 110 as an array of data fields. In an alternate embodiment, the storage module 365 comprises the format record 110. For example, the format record 110 may be stored on a hard disk drive of the storage module 365.

In one embodiment, the identification module 115, the characterization module 120, the comparison module 125, the validation module 130, and the target module 135 are software routines executed by the processor module 140. For example, the processor module 140 may read a file name and extract the file extension while executing the identification module 115. The file may reside in the memory module 105 or in the storage module 365. In an alternate example, the file may reside on a remote device in communication with the data processing device 300 through the network module 345. The data processing device 300 comprises the modules of the present invention for validating that the file format of a file matches the file extension of the file.

In one embodiment, the validation module 130 executing on the processor module 140 validates the file and communicates the validation through the north bridge module 320 and the south bridge module 325 to the hardware security module 140. In a certain embodiment, the hardware security module 140 transfers the validated file during a secure file transfer operation and does not transfer invalid files.

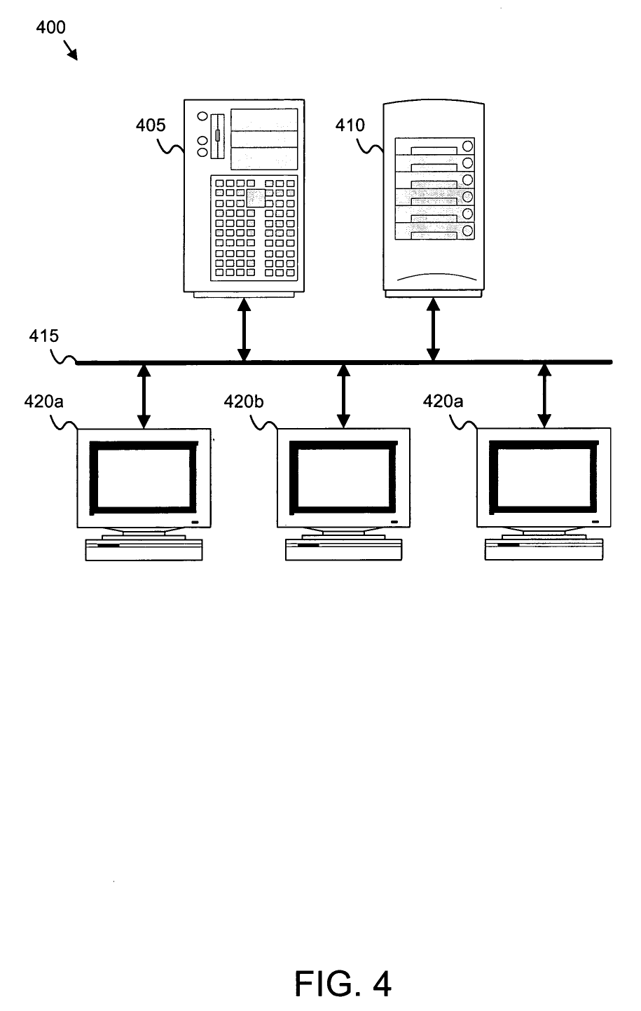

FIG. 4 is a schematic block diagram illustrating one embodiment of a network system 400 of the present invention. As depicted, the system 400 includes a server 405, a storage device 410, a network 415, and one or more data processing devices 420. Although the depicted system 400 is shown with one server 405, one storage device 410, one network 415, and three data processing devices 420, any number of servers 405, storage devices 410, networks 415, and data processing devices 420 may be employed.

The storage device 410 may be an array of hard disk drives, a magnetic tape drive, an optical storage drive or the like. In one embodiment, the server 405 comprises the data processing device 300 as depicted in FIG. 3, the data processing device 300 comprising the format record 110, the identification module 115, the characterization module 120, the comparison module 125, the validation module 130, and the target module 135. The network 415 allows the server 405, the storage device 410, and the data processing devices 420 to communicate.

In one embodiment, the server 405 backs up a plurality of files from the data processing devices 420 to the storage device 410. The validation module 130 of the server 405 may validate that the file format of each file matches the expected file format corresponding to the file extension of the file. In addition, the validation module of the server 405 may allow the back up of validated files and block the back up of files that are not validated.

In an alternate embodiment, the validation module 130 of the server 405 validates a file that is transported over the network 415. For example, a first data processing device 420a may request a file from a second data processing device 420b. In one embodiment, a web browser program executing on the first data processing device 420a makes the request for the file. In a certain embodiment, the server 405 detects the transport operation of the file and the identification module 115, the characterization module 120, the comparison module 125, and the validation module 130 validates that the file format of the file matches the expected file format for the file extension of the file before allowing the transport operation to proceed. If the validation module 130 of the server 405 cannot validate the file, the validation module 130 may block the transport operation.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

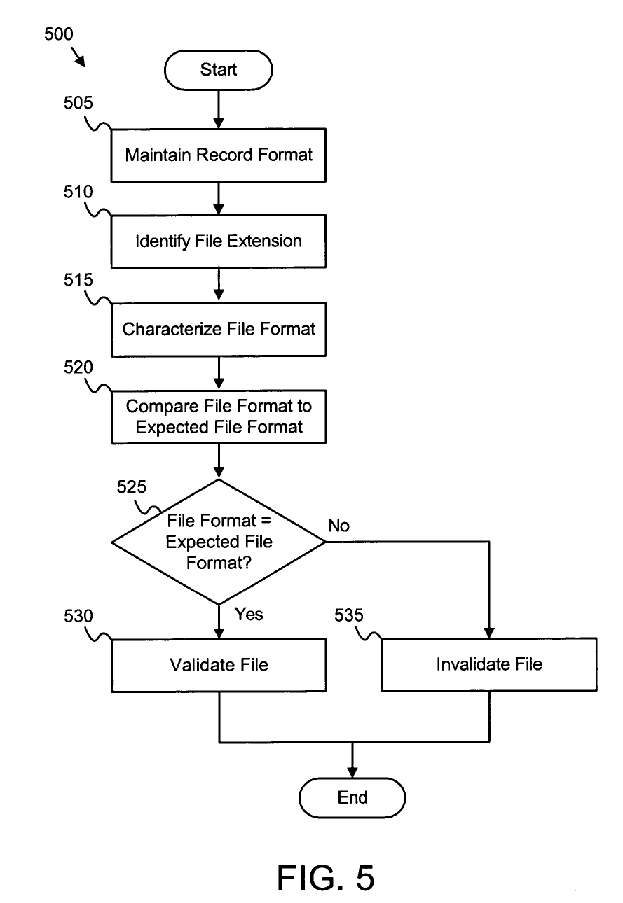

FIG. 5 is a schematic flow chart diagram illustrating one embodiment of a validation method 500 of the present invention. A memory module 105 maintains 505 a format record 110. In one embodiment, the format record 110 is a data store comprising a file extension field and one or more expected format descriptor fields. The descriptor fields may describe characteristics common to files of the same type and with the same file extension.

An identification module 115 identifies 510 the file extension of a file. In one embodiment, the file extension is parsed from the file name. In a certain embodiment, the file extension is the text following the right most period in a file name. For example, the identification module 115 identifies 510 the file extension of a file named ‘customerpresentation.2004.doc’ as ‘doc.’ In an alternate embodiment, the file extension is parsed from within the file.

A characterization module 120 characterizes 515 the file format of the file. In one embodiment, the characterization module 120 applies a common characteristic algorithm to each file. For example, the characterization module 120 may identify ifa file has one of a specified group of file formats such as audio formats, video formats, and the like. If the file does not have one of the specified formats, the characterization module 120 characterizes 515 the file as having an unknown file format. In addition, the characterization module 120 characterizes 515 the file format of the file as an identified file format if the file format is one of the specified file formats.

In one embodiment, the characterization module 120 characterizes 515 the file format using data from the format record 110. The characterization module 120 uses the file extension identified 510 by the identification module 115 to reference an expected file format in the format record 510. In a certain embodiment, the expected file format describes how to characterize 515 the file. For example, the expected file format may specify an offset and a data word in a file. The characterization module 120 may read a data word from the file at the offset location to characterize 515 the file format of the file.

The comparison module 125 compares 520 the file format of the file to the expected file format corresponding to the file extension of the file. In one embodiment, the comparison module 125 references the expected file format of the format record 110 corresponding to the file extension for directions on comparing the file format and the expected file format. For example, the expected file format may comprise a frequency range for occurrences of a specified data word throughout a file while the characterization module 120 may characterize 515 the file format by calculating the frequency of occurrences of the specified data word in the file. The expected file format may direct the comparison module 125 to compare 520 the file format and the expected file format by testing if the file format frequency is within the range of frequencies specified by the expected file format.

If the comparison module 125 determines 525 that the file format is equivalent to the expected file format, the validation module 130 validates 530 the file. In addition, if the comparison module 125 determines 525 that the file format is not equivalent to the expected file format, the validation module 130 invalidates 535 the file. The method 500 validates that the file format of a file matches the expected file format for the file extension of the file.

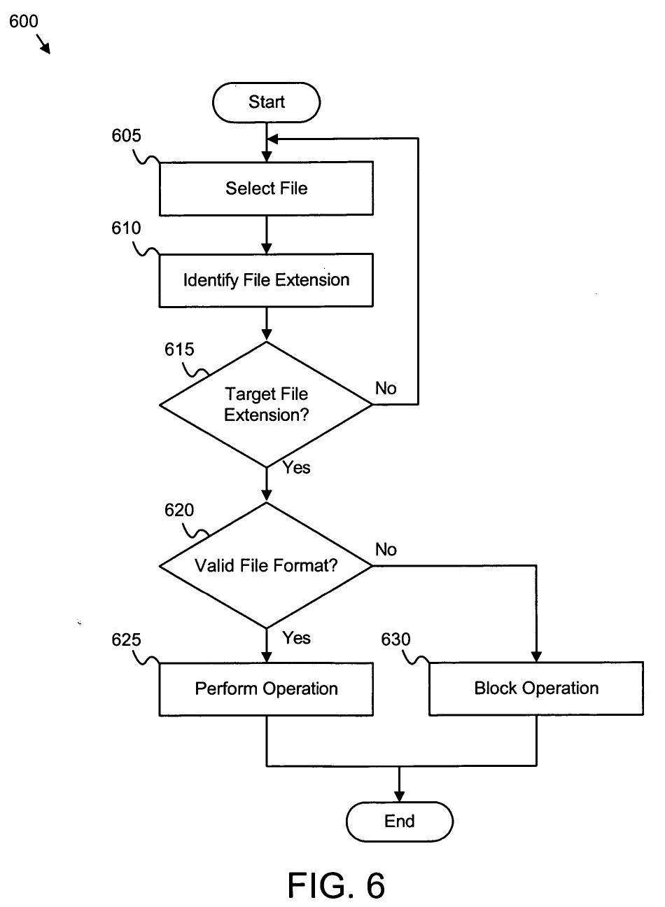

FIG. 6 is a schematic flow chart diagram illustrating one embodiment of an operation validation method 600 of the present invention. In one embodiment, a target module 135 selects 605 a file. The file may be the next file targeted for an operation such as a back up operation, a transport operation, or the like. An identification module 115 identifies 610 a file extension of the file and the target module 135 determines 615 if the operation is to be performed on the file. For example, in one embodiment the target module 135 only determines to perform a back up operation on source code files with a ‘c’ file extension. If the target module 135 determines that the operation is not to be performed on the file, the target module 135 selects 605 a next file. For example, the target module 135 may be configured to not back up files with specified file extensions such as file with a ‘mp3’ file extension. Therefore if the target module 135 determines 615 that the ‘mp3’ file extension of a file is not targeted for the back up operation, the target module 135 selects 605 the next file without backing up the ‘mp3’ file.

If the target module 135 determines 615 the operation is to be performed on the file, the identification module 115, characterization module 120, comparison module 125, and validation module 130 validate 620 the file using the method 500 described in FIG. 5. If the validation module 130 validates 530 the file, the validation module 130 allows the performance 625 of the operation of the file. For example, the validation module 130 may allow the performance of a back up operation on the file. If the validation module 130 invalidates 535 the file, the validation module 130 blocks 630 the performance of the operation on the file. For example, the validation module 130 may block 630 the back up operation from saving the file to a back up storage device. The method 600 selects files for validation 530 prior to performance 625 of an operation.

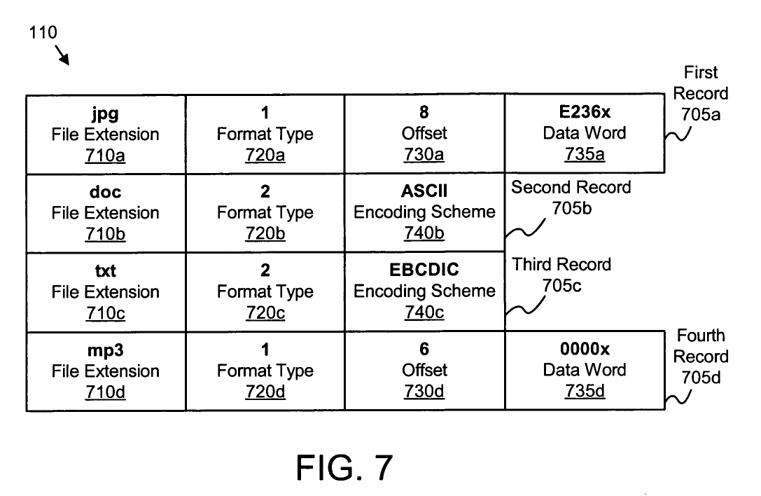

FIG. 7 is a schematic block diagram illustrating one embodiment of a format record 110 in accordance with the present invention. The format record 110 in the depicted embodiment includes one or more records 705 comprising one or more file extension fields 710, one or more format type fields 720, one or more offset fields 730, one or more data word fields 735, and one or more encoding scheme fields 740. Although the format record 110 is depicted with file extension fields 710, format type fields 720, offset fields 730, data word fields 735, and encoding scheme fields 740 for four (4) file extensions, 710a, 710b, 710c, 710d, any number and type of fields may be used to describe any number of file extensions.

In one embodiment, the records 705 of the format record 110 are stored as an array of data fields. In an alternate embodiment, the records 705 are stored as list of values, with each record 705 separated by a delimiter. The file extension field 710 stores a file extension. For example, the first file extension field 710a stores the file extension ‘jpg.’ In the depicted embodiment, the first format type field 720a, the first offset field 730a, and the first data word field 735a comprise the expected file format for the file extension ‘jpg.’ The first format type field 720a value of one (1) may direct the characterization module 120 to characterize 515 the file format of a file by reading a data word in a file at the offset of eight bytes (8B) from the first offset field 730a, wherein the data word is represents the file format. In addition, the first format type field 720a value of one (1) may direct the comparison module 125 to compare 520 the data word to the specified hexadecimal data word ‘E236’x of the first data word field 735a.

In an alternate example, the fourth file extension field 710d for the file extension ‘mp3’ corresponds to the expected file format comprising the fourth format type field 720d, the fourth offset field 730d, and the fourth data word field 735d. The fourth format type field 720d value of one (1) indicates that a file may be characterized 515 as having an ‘mp3’ format if the hexadecimal data word ‘0000’x of the fourth data word field 735d is located at the offset of six bytes (6B) specified by the fourth offset field 730d.

The file extension ‘doc’ stored in the second file extension field 710b corresponds to the expected file format comprising the second format type field 720b and the second encoding scheme field 740b. The second format type field 720b value of two (2) may direct the characterization module 120 to characterize 515 a file by determining the character encoding scheme of the file. In addition, the second format type field 720b value of two (2) may direct the comparison module 125 to compare 520 the character encoding scheme of the file with the ASCII character encoding scheme as indicated by the second encoding scheme field 740b. In an alternate example, the third format type field 720c value of two (2) may direct the characterization module 120 determine the character encoding scheme of the file and direct the comparison module 125 to compare 520 the character encoding scheme of the file with the EDCDIC character encoding scheme as indicated by the third encoding scheme field 740c.

The present invention is the first to combine comparing an expected file format corresponding to the file extension of a file with a characterization of the file format of the file, and validating the file if the expected file format and the file format are equivalent. In addition, the present invention is the first to determine if an operation should be performed on a file, and if the operation should be performed, to block the operation for invalid files. The present invention may be used to prevent the propagation of illegal files such as copyright protected files that may not be propagated or of bulky files such as video files. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to validate a file, the apparatus comprising:
a format record comprising an expected file format and a corresponding file extension;
an identification module configured to identify a file extension of a file;
a characterization module configured to characterize a file format of the file;
a comparison module configured to compare the file format of the file to the expected file format for the file extension of the file; and
a validation module configured to validate the file if the file format matches the expected file format.

2. The apparatus of claim 1, wherein the expected file format is an expected file format identifier, the characterization module is configured to read a file format identifier from the file, and the comparison module is configured to compare the file format identifier with the expected file format identifier.

3. The apparatus of claim 2, wherein the expected file format identifier is a specified data word at a specified offset in the file.

4. The apparatus of claim 1, wherein the expected file format is an expected character encoding scheme, the characterization module is configured to identify a character encoding scheme of the file, and the comparison module is configured to compare the character encoding scheme with the expected character encoding scheme.

5. The apparatus of claim 1, further comprising a target module configured to determine if an operation is to be performed on the file and wherein the validation module is configured to block the operation if the file is not validated.

6. The apparatus of claim 5, wherein the operation is a backup operation.

7. The apparatus of claim 1, wherein the validation module further validates the file in cooperation with a hardware security module configured to validate secure file transfers.

8. An apparatus to scan files, the apparatus comprising:
a format record comprising an expected file format and a corresponding file extension;
an identification module configured to identify each file extension of a plurality of files;
a characterization module configured to characterize a file format of each file;
a comparison module configured to compare the file format of each file to the expected file format for the file extension of each file; and
a validation module configured to validate each file if the file format is equivalent to the expected file format.

9. A system to validate a file, the system comprising:
a memory module comprising:
a format record comprising an expected file format and a corresponding file extension; and
a processor module comprising:
an identification module configured to identify a file extension of a file;
a characterization module configured to characterize a file format of the file;
a comparison module configured to compare the file format of the file to the expected file format for the file extension of the file; and
a validation module configured to validate the file if the file format matches the expected file format.

10. The system of claim 9, wherein the expected file format is an expected file format identifier, the characterization module is configured to read a file format identifier from the file, and the comparison module is configured to compare the file format identifier with the expected file format identifier.

11. The system of claim 9, wherein the expected file format is an expected character encoding scheme, the characterization module is configured to identify a character encoding scheme of the file, and the comparison module is configured to compare the character encoding scheme with the expected character encoding scheme.

12. The system of claim 9, the processor module further comprising a target module configured to determine if an operation is to be performed on the file and wherein the validation module is configured to block the operation if the file is not valid.

13. The system of claim 12, wherein the operation is a backup operation.

14. The system of claim 9, further comprising a network configured with a plurality of data processing devices and wherein the format record, the identification module, the characterization module, the comparison module and the validation module are configured to validate a plurality of files on the data processing devices.

15. The system of claim 14, wherein the validation module is further configured to block transport of the file over the network if the file is not valid.

16. The system of claim 9, wherein the validation module further validates the file in cooperation with a hardware security module configured to validate secure file transfers.

17. A signal bearing medium tangibly embodying a program of machine-readable instructions executable by a digital processing apparatus to perform operations to validate a file, the operations comprising:
maintaining a format record comprising an expected file format and a corresponding file extension;
identifying a file extension of a file;
characterizing a file format of the file;
comparing the file format of the file to the expected file format for the file extension of the file; and
validating the file if the file format matches the expected file format.

18. The signal bearing medium of claim 17, wherein the expected file format is an expected file format identifier and the instructions further comprise operations to read a file format identifier from the file and compare the file format identifier with the expected file format identifier.

19. The signal bearing medium of claim 17, wherein the expected file format is a character encoding scheme and wherein the instructions further comprise operations to identify the character encoding scheme of the file and compare the character encoding scheme with the expected character encoding.

20. The signal bearing medium of claim 17, wherein the instructions further comprise operations to determine if an operation is to be performed on the file and to block the operation if the file is not valid.

21. The signal bearing medium of claim 20, wherein the operation is a backup operation.

22. The signal bearing medium of claim 17, wherein the instructions further comprise operations to validate the file in cooperation with a hardware security module configured to validate secure file transfers.

23. The signal bearing medium of claim 17, wherein the instructions further comprise operations to validate the files of a plurality of data processing devices on a network.

24. The signal bearing medium of claim 17, wherein the instructions further comprise operations to block transport of the file over a network if the file is not valid.

25. The signal bearing medium of claim 24, wherein transporting the file is requested by a web browser.

26. The signal bearing medium of claim 17, wherein the instructions further comprise operations to block access to the file by an application program if the file is not valid.

27. A method for validating a file, the method comprising:
maintaining a format record comprising an expected file format and a corresponding file extension;
identifying a file extension of a file;
characterizing a file format of the file;
comparing the file format of the file to the expected file format for the file extension of the file; and
validating the file if the file format matches the expected file format.

28. The method of claim 27, wherein the expected file format is an expected file format identifier and the method further comprising reading a file format identifier from the file and comparing the file format identifier with the expected file format identifier.

29. The method of claim 27, wherein the expected file format is a character encoding scheme and the method further comprising identifying the character encoding scheme of the file and comparing the character encoding scheme with the expected character encoding scheme.

30. An apparatus for validating a file, the apparatus comprising:
means for maintaining a format record comprising an expected file format and a corresponding file extension;
means for identifying a file extension of a file;
means for characterizing a file format of the file;
means for comparing the file format of the file to the expected file format for the file extension of the file; and
means for validating the file if the file format matches the expected file format.
